(19) United States
(12) Patent Application Publication
(10) Pub. No.: US 2022/0335301 A1
(43) Pub. Date: Oct. 20, 2022

(54) PHYLOGENETIC REPLAY LEARNING IN DEEP NEURAL NETWORKS

(71) Applicant: DATAVALORIS S.A.S., Fontenay-sous-Bois (FR)

(72) Inventors: Jean-Patrice GLAFKIDES, Fontenay-sous-Bois (FR); Yevgeniy I. SHER, Charleston, SC (US)

(73) Assignee: DATAVALORIS S.A.S., Fontenay-sous-Bois (FR)

(21) Appl. No.: 17/589,699

(22) Filed: Jan. 31, 2022

Related U.S. Application Data
(60) Provisional application No. 63/119,397, filed on Nov. 30, 2020.

(51) Int. Cl. G06N 3/08

(52) U.S. Cl. CPC G06N 3/086

(57) ABSTRACT

Methods for improving neural networks by addressing the vanishing gradient include obtaining seed topologies in a deep neural network and iterating over the seed topologies using neuroevolution, with mutations to adjust the topologies or weights of the neural network. The performance of the various mutated models of the neural network is identified or modeled. An ideal, or champion, topology or model is thereby generated based on the neuroevolution. The path taken to arrive at the champion is monitored and stored, such that the series of evolutions along the evolutionary path from the seed model to the champion model is identified. After identifying the champion model and the associated mutation steps, the model may be further iterated by re-traversing the series of topological steps that led the champion model, while providing mutations or randomized weights for the various steps, which can identify further advancements or improvements to the neural network.

### FIELD

The field of the present disclosure relates in general to phylogenetic replay learning in deep neural networks.

### SUMMARY

One or more embodiments of the present disclosure relate to improved methods of improving neural networks in a manner that, in some embodiments, may address the vanishing gradient. To improve the deep neural network, one or more seed topologies of the deep neural network may be obtained. These may be automatically generated or manually provided. Using neuroevolution, the seed topologies may be iterated over with mutations to adjust the topologies and/or weights of the deep neural network. Additionally, while doing so, the performance of the various mutated models of the deep neural network may be identified and/or modeled. By identifying and/or modeling the performance, an ideal topology based on the neuroevolution may be identified, which may be referred to as a champion topology or champion model. When performing the neuroevolution, the path taken to arrive at the champion may be monitored and stored such that the series of evolutions when preceding along the evolutionary path from the seed model to the champion model may be identified.

In some embodiments, after identifying the champion model and the mutation steps to arrive at the champion model, the model may be further iterated upon by re-traversing the series of topological steps that led to the champion model while providing mutations and/or randomized weights for the various steps. Doing so may identify further advancements and/or improvements to the deep neural network. In some embodiments, the mutations along the neuroevolutionary path to the champion may include random weights when adding new nodes, modified synaptic weights, etc.

One or more embodiments of the present disclosure include a method that includes training an initial model on a first dataset, and iterating over multiple generations, with at least one mutation in each of the multiple generations, to identify a champion model. The method may also include storing a trace of evolutionary steps from the initial model to the champion model, and replaying the evolutionary steps with modified synaptic weights, random weights when adding new nodes, or a combination of both.

### BRIEF DESCRIPTION OF THE DRAWINGS

FIGS. 1-6 illustrate various embodiments described herein.

### DESCRIPTION

Though substantial advancements have been made in training deep neural networks, at least one problem still remains, the vanishing gradient. The very strength of deep neural networks, their depth, can also be a problem. This disclosure describes “Phylogenetic Replay Learning”, a learning methodology for Deep Neural Networks that in some embodiments may substantially alleviate the vanishing gradient problem. Unlike the residual learning methods, Phylogenetic Replay Learning may not restrict the structure of the model. Instead, it may leverage elements from Neuroevolution, using which a model's topology may be algorithmically and/or automatically constructed. Such a new approach may be able to produce a better performing model, and by calculating Shannon Entropy, it may be demonstrated that the deeper layers are trained much more thoroughly and contain statistically significantly more information than when a model is trained in a traditional brute force method.

I. Introduction

Nature evolved the nervous system through eons of trial and error, from the first apparition of the neuronal cell to the complex brains we possess today. The field of machine learning has made progress during the past decade, which may be related in part to the improvement of CPU power, data accessibility, optimization of deep neural network (DNN) algorithms, improvements in hardware, the use of GPUs, etc. Artificial neural networks are called deep when they have more than 3 layers of neurons (though some categorize DNN as those having greater than 9 layers), and they are capable of being tuned to reach a specific goal through the use of an optimization algorithm, mimicking the role of synaptic plasticity in biological learning. This approach has led to the emergence of highly efficient algorithms that may be capable of learning and solving complex problems [1].

Two of the main limitations of such algorithms are: 1. Their topologies are built empirically, and 2. Even with all the improvements in hardware, the deep neural networks are still affected by the vanishing gradient problem. Though this disclosure primarily addresses and/or mitigates the 2nd problem (the vanishing gradient), its use is demonstrated by applying it to a model that was evolved through neuroevolution. In the last few years some advancements have been made in automated model search and construction methods. These automated model construction or model search methods are commonly called neuroevolutionary methods, due to the use of evolutionary algorithms to search for optimal model architectures. These methods have demonstrated a strong ability to produce state of the art models. One or more methods consistent with the Phylogenetic Replay Learning (PRL) of the present disclosure may be combined with the neuroevolutionary method to leverage its ability to construct deep and complex networks from simple ones. Such a combination may be particularly advantageous.

Neuroevolution is a method that mimics nature by leveraging evolutionary computation to evolve DNN topologies, and to select an ideal, a satisfactory, and/or the best topology for a complex problem being solved. Neuroevolution is a synergy between two domains, artificial neural networks and evolutionary computation (a global search strategy that encompasses approaches like evolutionary strategies, genetic algorithms, evolutionary programming, etc.) [15].

Work has been done in the use of neuroevolution for deep neural network construction [3]. A number of such works exploring the use of evolutionary computation in deep network optimization [4] [5] [6] were produced by a research group at UBER, which specializes in neuroevolution. Similarly, research done at IBM [27] and at GOOGLE [28] have also explored this approach, and demonstrated its capabilities. Neuroevolution has been fairly successful and robust, demonstrating excellent results in numerous domains [7] [8] [9] with interesting results in some cases [18].

Despite this technology, it remains difficult to build models that generalize or adapt efficiently to complex problem domains and data. One of the bigger difficulties being faced when building complex and deep models that converge correctly, is the vanishing gradient problem [11] [14] which is yet to be solved [13]. It is this problem, the vanishing gradient, that the PRL approach consistent with one or more embodiments of the present disclosure may facilitate addressing, mitigating, and/or solving.

With the increasing number of layers that are used, the vanishing gradient problem can cause the gradient to become too small for effective weight parameter updating. This may be due to certain activation functions, like the sigmoid function, which squashes a large input space into a small one between 0 and 1. Thus, a large change in the input of the sigmoid function may cause a small change in the output, and with it the derivative also shrinks. This problem is exacerbated with deeper layering, the gradient decreases exponentially as propagation occurs down to the initial layers.

A small gradient means that the weights and biases of the initial (deeper) layers will not be trained effectively. Since these initial layers are often crucial to recognizing the core elements of the input data, it can lead to overall inability of the whole network to learn effectively.

This effect can be partially mitigated by using other activation functions, such as relu for example. Other ways of combating this problem are specific architectures, like the Residual neural network [20] which attempts to decrease the effect of this problem by linking every layer to the output layer. However, such approaches do not mitigate the effect sufficiently and may be too restrictive.

Such limitations call for the development of new methods specifically designed to enhance learning capabilities and counter the vanishing gradient effect. A method may be beneficial that will not be restricted to the use of specific neural topologies or activation functions.

The Phylogenetic Replay Learning (PRL) may utilize a trace of model's complexification, from a simple shallow version to the final complex DNN. When this trace is available, it performs re-training of the layers as it adds layer on-top of layer within the trace. This iterative re-training approach ensures that every layer was at some point the output layer (or close to it), and thus was affected by the gradient descent learning algorithm to a greater extent, while the deeper layers were “re-tuned” to work effectively in the deeper model. When this approach is combined with automated model architecture search, and/or when used in combination with neuroevolution, the system first evolves the final model from a simple initial seed model while also building its trace of mutations/ancestral models, and then it re-traces those evolutionary steps (the phylogeny), while re-training the model at every step on the same data as it complexifies the initial model.

In the following sections, the PRL method may be discussed in detail. First, the background of the pertinent domains may be discussed, such as neuroevolution and the vanishing gradient problem. Sample definitions of the terms used in this paper may be provided. In the methods section, a detailed PRL algorithm and the pseudocode it follows may be provided. In the results section, the experiments performed and their results may be presented. Finally, analysis and discussion of the results achieved may be provided.

A. The Vanishing Gradient Effect (VGE)

The most common neural network (NN) optimization algorithm is based on the use of stochastic gradient descent. This involves first calculating the prediction error made by the model and then using the error to estimate a gradient used to update each weight layer by layer, cascading backwards in the network. This error gradient is propagated backward through the network from the output layer to the input layer, updating the weights to minimize and/or otherwise reduce the difference between the actual NN output and the expected output.

It is useful to train NNs with many layers. The addition of deeper layers increases its capacity, making it capable of learning more complex mapping functions between input and output when a large training dataset is provided.

A problem with training networks with many layers (e.g. deep neural networks) is that the gradient diminishes dramatically as it is propagated backward through the network. The error may be so small by the time it reaches layers close to the input of the model that it may have very little effect. As such, this problem is referred to as the “vanishing gradients” problem.

B. Neuroevolution

Neuroevolution, in some circumstances, may refer to a machine learning technique that applies an evolutionary algorithm to construct artificial NNs, taking inspiration from the biological evolutionary process. Compared to other NN learning methods, neuroevolution is highly general; e.g., it may allow learning without explicit targets, with only sparse feedback, able to evolve arbitrary neural models and network structures guided by the problem domain and data.

C. Definitions

CHAMPION: includes a NN model (Topology and weights) representing the best model that neuroevolution is able to produce to solve a problem.

INITIAL MODEL: includes a simple seed model used as the starting point of model search in neuroevolution.

DIRECT DEEP-LEARNING (DDL): includes a standard/default training of a model using backpropagation (Adam, QProp, etc.) to differentiate it from the PRL method. It is a method that is applied to the DNN without the use of neuroevolution or PRL. In our experiments, the training algorithm used in the Keras framework was set to Adam. The DDL is also known as end-end training.

PARAMETERS: may include some or all variables that can be modified, in a NN these are primarily the synaptic weights of the network.

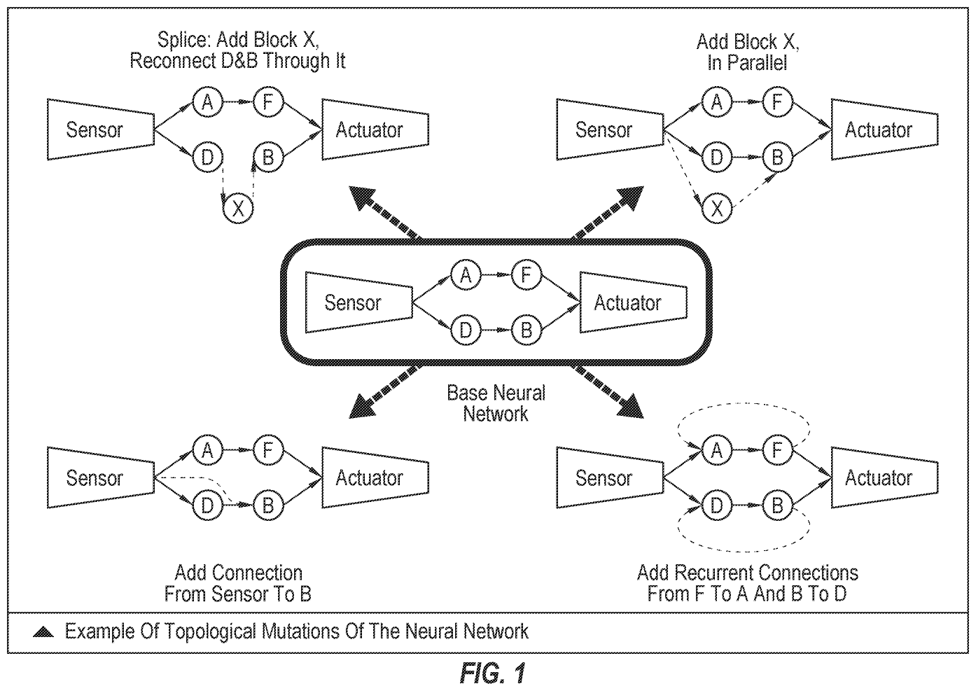

MUTATIONS: at each step of the evolutionary process we apply mutation(s) to the topology of the parent in order to create an offspring. A topological mutation (such as that illustrated with reference to FIG. 1) can add a node to the model, mutate existing node, remove a node, clone an existing node, add or change a link between two nodes, and/or swap two nodes, etc.

SELECTION PROCESS: may include the mechanism by which the algorithm selects the best entities according to their score (fitness function) and stores them in the “Hall of Fame” (HOF) list. For example, when 2 entities are evaluated the one with the best score/fitness is kept, and the other may be dismissed. The selection criteria may be based on model accuracy, but also potentially on model size, genetic diversity or training time, a weighted combination of all three, or any other factors or selection criteria.

HALL OF FAME: or HOF for short, is a list our neuroevolutionary system holds of the best performing agents/models. In our tests, HOF was set to the size of 10, which means that when models are evaluated, it only maintains a list of the 10 best performing models. Furthermore, it compares the different model topologies, and requires that the models being stored are all topologically different from one another. Thus, the 10 models stored within HOF are of different topologies. While 10 models are used as an example herein, any number of models including any number of parameters are within the scope of the present disclosure

PHYLOGENETIC REPLAY LEARNING (PRL): may include a method of re-training the model at every topological mutation step, following those mutational changes from seed (e.g., initial model) architecture to final topology (e.g., champion).

D. Other Methods to Reduce Vanishing Gradient Effect (VGE)

Several other approaches can be used to reduce the VGE, but none are perfect.
Activation functions, such as relu for example [21].
Normalized initialization layers [22], [26] and intermediate normalization layers [25], which enable networks with tens of layers to start learning/converging with stochastic gradient descent (SGD) with backpropagation [23].
Specific architectures, like the residual neural network which attempts to decrease the effect of this problem by linking every layer to the output layer [20].
Regularizing deep neural networks by noise: injects noise during the training procedure: adding or multiplying noise within the hidden units of the NNs [24]
Deep Cascade Learning method proposes a solution to alleviate the VGE [29] by training deep networks in a cascade-like, or bottom-up layer-by-layer, manner. it reduces the VGE but was not shown to be better than DDL.

All these solutions are compatible with the PRL approach. Using PRL does not preclude one from leveraging other methods as well.

E. Metrics

The metrics used for model comparison includes the Validation Accuracy. Early stopping was applied on the Validation loss, with the Accuracy used as the metric of learning.

In order to better understand the difference in the informational density of the models, Shannon Entropy [16] eq. 1, eq. 2, (listing 1) may be calculated. For example:

$$\begin{matrix}i \\ Pi = Pn ( 1 ) \\ i = 1 ( i )\end{matrix}$$

$$H = {-}_{i = 1}^{{x}^{n}} Pi ln ( Pi ) ( 2 )$$

### Listing 1. Shannon Calculation Code

weights=np . absolute (Model. get weights ( ) [0])

A=weights . flatten ( )

Pa=A/A. sum ( )

Shannon=−np . sum(Pa*np . log2 (Pa))

F. Dataset

PRL was tested on 3 datasets: MNIST, Fashion MNIST and CIFAR10. CIFAR10 was converted to grayscale with images reshaped to 28*28 pixels, to be the same shape as those within MNIST.

G. Tools

Tools were selected like Keras and Raise from DataValoris as their engine already provides the unrestricted deep learning neuroevolution. Finally, all experiments were performed on a server with an NVIDIA TESLA v100 GPU card.

Direct Deep-Learning (DDL) tools: For DDL experiments, the early stop patience was set to 9, and epoch number was set to 60 to avoid a bias where the DDL might not have enough time to train very deep networks.

Phylogenetic Replay Learning (PRL) Tools: To evolve models through neuroevolution we used the latest version of DataValoris' Raise Solution.

H. Seed Model

The Table I show the simple model used as the seed model 7,850 parameters and 1 hidden layer in a sequential architecture.

I. Selection Rules

The neuroevolutionary process uses selection based on a score generated by the Adam learning algorithm. The score used as a fitness is the epoch Validation accuracy (Val acc) of the model. The system may be set such that the learning rate is decreased when validation accuracy does not improve for 3 consecutive evaluations. Every generation 10 NNs are trained, then their scores are compared to the NNs in HOF. If a score of an offspring/mutant model within the current generation is higher than that of a model within the HOF that has the same topology, the mutant model replaces the model within the HOF. If the mutant model has the highest score, and has a topology not present within the HOF, the model with the lowest fitness within the HOF is removed, and the new model is added in its spot.

While various examples of tools, models, selection rules, etc. are described, it will be appreciated that any variations or substituations, omissions or additions, etc. are within the scope of the present disclosure.

III. Methods

PRL may include a combination of neuroevolution and re-training. It may create a model specific for the problem domain through model search, and may also alleviate the vanishing gradient descent through its final retraining.

The system allows the classical gradient descent method to affect each layer, even the very deep ones, more than a traditional learning approach. PRL does this by retraining each of those layers as the model is being evolved and new layers are added. Each new layer added has the chance of being trained as the first or second layer in the backprop cascade.

Framework used in this study was the official Keras framework. Datasets used are those made available within the official Keras framework. These datasets may or may not have been augmented during tests. The algorithms were developed in Python.

In some embodiments, a PRL algorithm may include the following two phases:

A. Phase 1: Generation of the Champion Mutation Path Through Neuroevolution

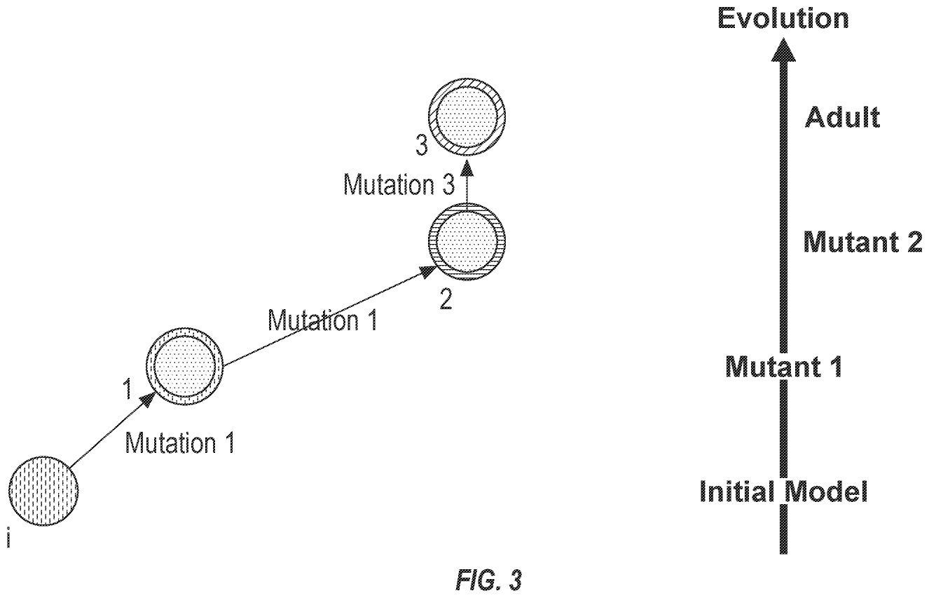

PRL may utilize the construction of the phylogenetic path (FIG. 3) of the model to be trained.

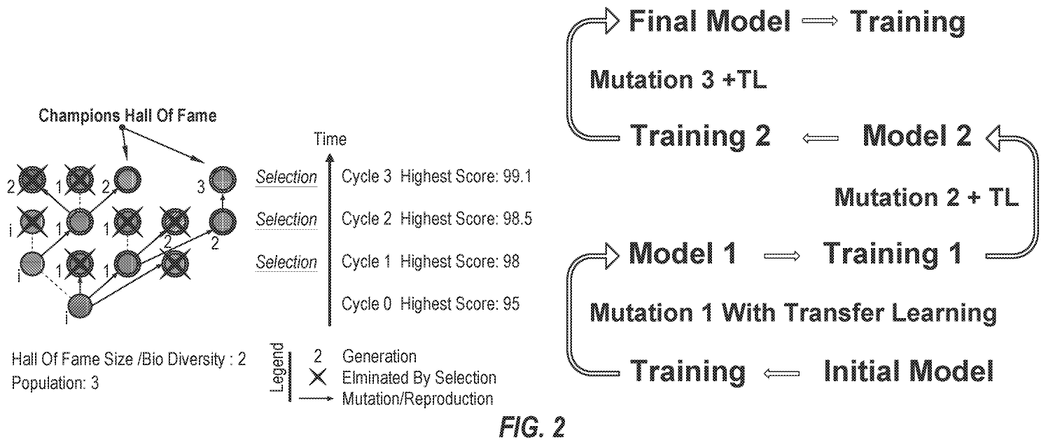

The first phase is meant to build the Champion model while recording its phylogenetic path (mutations that were applied sequentially to generate it). Neuroevolution is used to accomplish this, as illustrated in FIG. 2.

Neuroevolution generates a phylogenetic path (FIG. 3) of the best performing model aka the “champion.” In the example illustrated in FIG. 3, the champion has 3 ancestors. The figure also illustrates which topological mutations were applied to get from one model to the next.

B. Phase 2: Model Generation with PRL

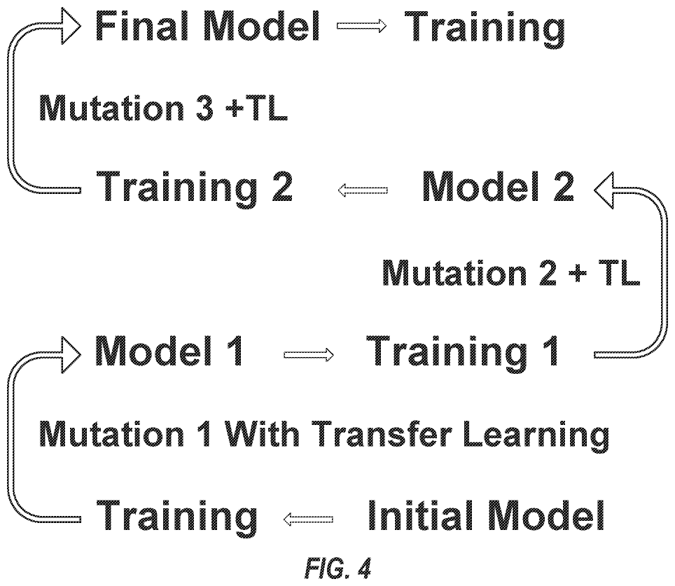

After generating a phylogenetic path that leads to the champion model, the path may be replayed (e.g., as illustrated in FIG. 4) from the seed model to champion model.

When replaying the phylogenetic path, the process may be able to 1. Generate the seed model with a new set of random synaptic weights, and/or 2. Generate random weights when adding new nodes during mutations. This then may create the final model with the same topology as the champion model but with its own set of parameters.

One or more operations may be studied experimentally as follows:

1) Phylogenetic path recording: First an initial simple seed model may be trained on a dataset. Using the neuroevolutionary approach, over multiple generations a more complex and better performing NN architecture may be evolved, and the evolutionary steps leading from the seed NN to the final architecture are recorded in its trace list. The final architecture may be referred to as the Champion model.

2) PRL evaluation: Having the trace from the initial model to the champion, the initial model may be re-trained using the PRL method X# of times. Using the PRL method, after the addition of each mutation in the trace, the system may be retrained using Adam, from seed to champion topology, without resetting the weights between each mutation (in some sense, similarly to transfer learning). This may provide the average performance (average of X# of times) of the same champion topology, but trained using the PRL method.

3) Champion model DDL retraining: The champion model may be re-initialized with random weights and trained on the dataset X# of times using the standard learning approach (Adam). This may be done to calculate the average performance of the model trained in the standard manner (which may be referred to as“directly applied deep-learning”, or DDL).

4) Reproducibility testing: In order to confirm the results and test the reproducibility of the method, another Champion may be created and PRL again applied.

5) Data storage efficiency testing: the efficiency of data storage in complex models trained through PRL may be evaluated.

6) Transferability testing: To evaluate the transferability of the Model using the PRL process, the same champion may be tested on other Datasets by retraining it using DDL and/or the PRL method.

IV. Results of Experiment 1

In this section, generation of a champion and storage of the phylogenetic path may be described. Additionally, replaying the recorded mutation path, gathering the resulting statistics, and/or comparing them to the other learning results may also be described.

A. Phase 1: Champion 1 Generation

The experiment was setup as follows:

When using the neuroevolutionary method, a seed population of 20 random minimalistic models are generated.

20 agents are generated during every cycle (by way of mutation) from the best agents within the HOF (with an example HOF max size of 10), where the probability of using any one agent as the parent of the mutant offspring being that parent's relative fitness (accuracy) as compared to other HOF agents.

This experiment used the MNIST dataset available within the Keras framework.

The evolutionary engine applied 1-2 (randomly chosen) mutations to create a mutatant offspring model from the parent (although any number of mutations, including zero, may be selected).

The deep learning parameters used were as follows: 20 epochs with early stopping based on a patience of 3, where patience is based on the Validation loss metric, although any deep learning parameters may be used.

In the present disclosure, the number of parents since origin may be referred to as the agent's generation number. In classic genetic algorithms the generation may correspond to “cycles” in the present disclosure. For example, an agent of Generation 3 and Cycle 8 means it appeared on the 8th iteration and has 3 ancestors (e.g., it could have appeared at minimum between cycle 3 to 10).

From the list of champions generated using the neuroevolutionary method during Phase 1, the best one may be selected as shown in Table II.

Following the example, the chosen champion has 409158 parameters spread between 25 nodes that are 13 layers deep. It has been generated on the 96th cycle and is generation 19 (e.g., the chosen champion has 19 ancestors).

The accuracy of the chosen champion is (val acc) 99.44% close to state of the art on non-augmented MNIST dataset.

The mutations recorded at each step that lead to the final champion topology are displayed in Table III. At every evolutionary step 1-2 mutation(s) were applied. The number of mutations applied at each step may be limited to a maximum of 2 in order to generate a complex model with small changes between each step, which allows PRL to work on smaller parts during each mutation. It will be appreciated that any number of mutations may be utilized.

Table IV presents a base of comparison, it shows PRL scores of the Champion NN at each step of its evolutionary path. Those scores have been used as the selection criteria for HOF entrance of the offsprings during the evolutionary process.

As an example, this first result shows that the model has increased in size. This is an example of behavior of an evolutionary algorithm if no size restrictions are used during model generation and mutation.

The Shannon Entropy also decreases from generation to generation, from 12.51 to 8.90. Such a reduction may correspond to the increase in organization of the model weights, and its ability to better store information. Such a reduction may represent a transition from an almost random set of weights to a set of weights that store useful information, e.g., a more organized distribution.

B. Phase 2: Learning Statistics

During Phase 2, the result metrics of the two different learning approaches may be gathered to evaluate the impact of using PRL as compared to DDL.

1) DDL of champion 1: To evaluate the learning capacity of the model 50 runs were conducted using the standard learning method applied directly to the final champion model. The initial weights in each experiment were randomly generated. This number of runs permitted calculation of a statistically relevant standard deviation.

In theory, the DDL of the champion model could have the same performance as the original champion (and potentially higher) but the probability that these 409158 random parameters reach an optima is very low. The more complex and deeper the model, the greater the effect PRL method is expected to produce by countering the vanishing gradient effect (VGE).

To perform these experiments and to maximize the probability of reaching a favorable local minimum, 60 epochs per run were used, and patience was set to 6.

During the experiments, a maximum of 53 epochs were used before early stoppage occurred. An average of 45 epochs out of 60 were used before early stoppage was triggered.

During Phase 1 of the PRL method, the Champion achieved an accuracy of 99.44%. The associated Shannon entropy was determined to be 8.90037. The best score/accuracy achieved using DDL of the champion model was 99.05%, a statistically significant difference (see, e.g., Table. V). In some circumstances, the VGE may be the root cause of the difference in the results of the PRL method compared to the DDL Method. Furthermore, Shannon entropy of the best performing model trained using the standard approach (9.1227) is also higher than the entropy of the champion model produced during phase 1 of the PRL method.

The application of DDL to the model is also less efficient than that produced through phase 1 of the PRL method.

2) Phylogenetic Replay Learning: From the initial model, the mutations are applied based on the phylogenetic path of the Champion model. The weights are randomly generated for the new mutated layers as well as seed model. The PRL experiment was run 50 times to gather data on which to base the averages. Weights were not reset between mutations (which can be considered as transfer learning).

Table VI illustrates the results of the 50 PRL experiments. For example, in the results, the best score reached was 99.40% with an average of 99.26%. This score is very close to that of the original champion model, which reached 99.44%. Thus, there is substantial consistency.

3) Comparison of Results:

The scores produced by the PRL and/or the DDL methods are lower than those produced by the Champion itself (which followed the optimal path). Such a result may be due to the randomly generated weights during each step. The standard deviation of experiments involving PRL may also be low, e.g., there is performance consistency in the results produced by PRL.

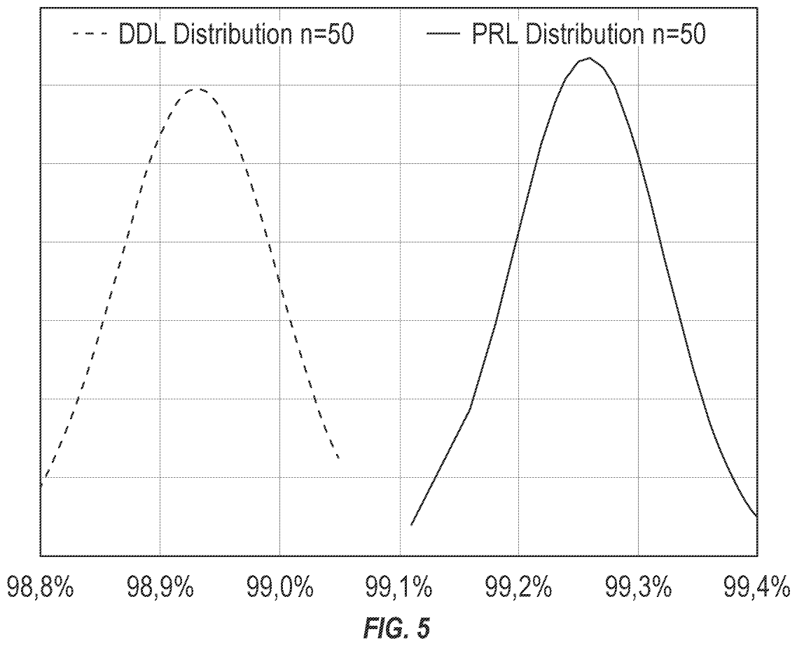

The score produced by PRL is better than that produced by DDL. With an average maximum of 99.26% compared to 98.93% of DDL, the difference is statistically significant (p<0.001—see, e.g., the results in Table. VII) and distribution well separated (see, e.g., FIG. 5). Similarly, comparing both maximums of 99.40% (PRL) to 99.05% (DDL), a statistically significant difference is observed.

The standard deviation of PRL is lower (e.g., better) than that of the DDL (see, e.g., Table VII), illustrating that PRL is a more robust approach, and more resilient to random weight initialization.

During the PRL, the Shannon value consistently decreased at every step (see, e.g., Table VI) of the process. Such a result may represent an increasing organization/informational density of the model while the model complexity increase at each step.

The Shannon entropy of the PRL based model is lower (e.g., better) than that of the DDL based model (e.g., 8.81 versus 9.16).

The last two results suggest that PRL alleviates the VGE.

Table VIII illustrates that when using DDL the Shannon entropy of the last layers in the model are lower than those in the PRL trained models (e.g., as illustrated by the bold values for the lowest Entropy in Table VIII).

The lower values of Shannon entropy suggest that the standard training (e.g., DDL) is primarily affecting the last layers within the model due to the VGE. Stated another way, using the standard training approach, the model may store most of its information in the last layers. In PRL, the weight adjustment may be more distributed, and learning is conducted more evenly at every layer within the model. Such distribution may result in the total Shannon entropy being lower in PRL.

Table IX illustrates that if at each step, the same model is trained (e.g., resetting its weights first) using DDL, it both: achieves lower final accuracy (e.g., it performs worse than the PRL), and based on its Shannon entropy score, stores less information. The DDL performance deviation from the PRL trained model only increases as the model becomes more complex and grows deeper.

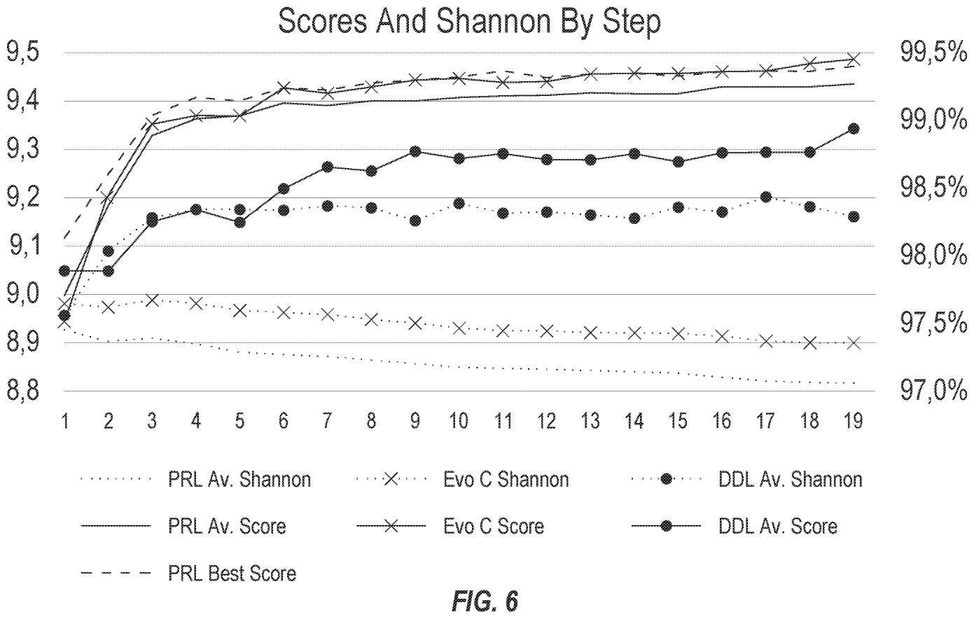

FIG. 6 illustrates a visual graph of the results. 3 experimental results are displayed: 1. Evolution score retrieved during phase 1 of Champion creation. 2. Mean DDL score at each evolutionary step of the Champion. 3. Mean PRL score of the Champion. Plain lines represent the Score, dotted lines represent Shannon entropy, and for comparison the PRL Best score is shown as a dashed line. We see that the Shannon score at each step when using DDL is higher than that of the PRL based model.

In some embodiments, an artificial PRL approach may be used, where any deep model is re-built up one layer at a time and retrained at every step using either an artificially created output layer (of the correct output layer length) until the last layer [17], or by re-attaching the last layer to each consecutive layer and then re-training the model.

V. Discussion

A. Reproducibility

1) Reproducibility of PRL results: the whole experiment may be repeated using another framework, PlaidML, and another seed model to generate a new champion. For control, the same dataset and the same PRL method may be used.

The seed model 2 (see, e.g., Table X) used in this experiment is narrower but deeper, as compared to the one in the previous experiment.

Table XI illustrates the metrics of Champion 2 generated from the seed model 2 (e.g., Table X) during phase 1 of PRL.

Champion 2 topology generated is smaller but with a more complex structure than champion 1 used in the first experiment. Furthermore, Champion 2 may be harder to train than “seed model 2.” For example, Champion 2 epoch time may be 15 times that of “seed model 2.”

Applying DDL to Champion 2 gives the following results: DDL Average score: 98.90% +/−0.001 (n=16); DDL Maximum score: 99.08%. The score observed using DDL with Champion 2 topology may be lower than that of the Champion 2 itself (see, e.g., Table XI). For example, the score using DDL may be 99.08% at max versus 99.43% for Champion 2 itself.

Table XII illustrates that PRL is still more efficient than the DDL approach. The original score of the champion is on average better, which is consistent with the earlier experiments.

One consideration of the previous experiment may be that the initial steps with simpler topology where the VGE is not important had higher scores when using DDL than when using PRL. From step 12 and onward the accuracy/performance achieved by PRL is higher, even though the model was more complex.

2) Complexity of model criteria: When referring to model complexity, the model may include a large number of branches, may be deep, and may be nonsequential. In some embodiments, the more complex (in terms of topology) a model is, the more beneficial it would be to train it using PRL. For example, another experiment was conducted where the neuroevolutionary selection rules were changed.

In this third experiment, a rule was added to the selection process to put more weight on selecting those models which trained the quickest (e.g., model training speed was weighted into the final fitness score). With this approach a model with the same accuracy as another, but with a shorter learning speed (e.g., epoch time) may be selected to enter the HOF. This resulted in the generation of a champion (e.g., Champion 3) with many branches and/or a deep structure, that was also quick to train.

Champion 3 generated:

Score: 0.9940 Shannon: 8.4799

DDL average results for champion 3 model:

Score: 0.9937 Shannon: 8.4150

PRL average results for champion 3 model:

Score: 0.9933 Shannon: 8.3535

In this experiment, the Shannon value may still be lower when using PRL as compared to DDL. But, the difference in the results of this experiment may be less drastic. For example, the seed model's learning time and the champion's learning time are almost the same. As a comparison, in the first test, the champion 1 took three times longer to train by epoch than the corresponding seed model. During the second test it took fifteen times longer for champion 2 to train an epoch versus the corresponding seed model.

The PRL complexity definition may include not only the topological complexity (total parameters, total nodes and node links), but may also be linked to the learning efficiency (amount of time it takes to learn) of the model. The more difficult it is for the model to learn a dataset, the more complex its structure needs to be, and the greater effect PRL method may have on its training.

B. Transferability

In one experiment, PRL may be applied to champion 1 again, but it may be trained on a different dataset. The purpose of this experiment is to evaluate if a model with the corresponding recorded evolutionary path can be applied on another but related dataset.

Experiment 4: Fashion MNIST: The model is re-applied to the Fashion MNIST dataset provided within the Keras framework. This dataset has the same input and output shape as the standard MNIST. In this dataset, the classification is done on various fashion objects (dresses, shoes, ext.) rather than digits. This dataset is found to be more complex than the standard MNIST.

DDL average results for champion 1 applied to Fashion M: Score: 0.9044 Shannon: 9.0238

PRL average results for champion 1 applied to Fashion M: Score: 0.9198 Shannon: 8.4813

This experiment shows that we can re-apply PRL to an existing model, and train it on a related but different dataset. Additionally, when doing so, the PRL method may provide a better result than DDL.

As a comparison, a typical convolutiononal NN applied to the Fashion MNIST is 91.4% without data augmentation [19]. Our 91.98% is a competitive result that outperforms the state of the art, even though the model trained by PRL was not evolved for that specific dataset.

Table XIII illustrates that PRL is better able to alleviate the VGE. The first layers have better Shannon entropy values when a model is trained through PRL, and the last layers have better entropy values when DDL is used to train the model.

Experiment 5: Cifar10 Grey: In an additional experiment, the model may be trained on the CIFAR10 dataset converted to greyscale (C10G). This dataset is more difficult than the MNIST. For this experiment, the dataset was converted to the 28*28*1 resolution, and gray-scaled such that the same model may be used repeatedly to its transferability.

DDL average results for champion 1 applied to C10G: Score: 0.5440+/−0.003796 Shannon: 9.1690

PRL average results for champion 1 applied to C10G: Score: 0.6501 Shannon: 8.9345

Such results again illustrate the ability of the PRL method to generalize (e.g., apply to many different datasets), and retrain an existing model on a new but related dataset. In experimental results, the PRL method consistently produced better results than DDL, both in accuracy and information density (e.g., Shannon entropy values).

VI. Conclusion

Based on the experiments and results, PRL may outperform DDL, for example, by alleviating the VGE problem. Additionally, the Shannon entropy values may be lower in deeper layers in the models trained by PRL as compared to DDL. Furthermore, PRL may be more resilient to random weight initialization as compared to DDL. In re-runs of the PRL experiment on the same seed model and with the same phylogenetic path, but with each seed model having randomly generated initial synaptic weights, the PRL method appeared to perform in a superior manner to the DDL method. Additionally, the performance of the evolved champion models were all very similar.

Experiments on transferability illustrate that the method may be effective in retraining models on related datasets. For example, PRL may be used in transfer learning, where a model with the associated phylogenetic path can be effectively retrained on another dataset or an updated version of the same dataset and earlier training may be applicable, at least in part, to the new dataset.

In some embodiments, the combination of neuroevolution where model/architecture evolution is synergized with training, may yield better performing systems, as compared to systems where the model is trained all at once (DDL). Additionally or alternatively, the PRL method might be particularly effective in training very deep and very complex models, where DDL might struggle.

In some embodiments, the different components, modules, engines, and services described herein may be implemented as objects or processes that execute on a computing system (e.g., as separate threads). While some of the systems and processes described herein are generally described as being implemented in a specific controller, implementation in software (stored on and/or executed by general purpose hardware) are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

### REFERENCES

[1] Silver David, et al, “Mastering the game of Go with deep neural networks and tree search.”, “Nature 529.7587, pp-484-489”, 2016.

[2] Nicolas Vecoven; Damien Ernst; Antoine Wehenkel; Guillaume Drion, “Introducing neuromodulation in deep neural networks to learn adaptive behaviours”, “https://doi.org/10.1371/journal.pone.0227922”, 2020.

[3] Felipe Petroski Such, et al, “Deep Neuroevolution: Genetic Algorithms Are a Competitive Alternative for Training Deep Neural Networks for Reinforcement Learning”, arXiv preprint arXiv:1712.06567, 2017.

[4] Xingwen Zhang, Jeff Clune, Kenneth O. Stanley, “On the Relationship Between the OpenAI Evolution Strategy and Stochastic Gradient Descent”, arXiv preprint arXiv:1712.06564, 2017.

[5] Lehman Joel, et al, “ES Is More Than Just a Traditional Finite-Difference Approximator”, arXiv preprint arXiv:1712.06568, 2017.

[6] Conti Edoardo, et al, “Improving Exploration in Evolution Strategies for Deep Reinforcement Learning via a Population of Novelty-Seeking Agents”, arXiv preprint arXiv:1712.06560, 2017.

[7] F. Gomez, J. Schmidhuber and R. Miikkulainen, “Accelerated neural evolution through cooperatively coevolved synapses”, Journal of Machine Learning Research, 9(May):937-965, 2008.

[8] R. De Nardi, J. Togelius, O. Holland and S. M. Lucas, “Evolution of neural networks for helicopter contrai: Why modularity matters”, ln Proceedings of the IEEE Congress on Evolutionary Computation, 2006.

[9] V. Heidrich-Meisner and C. lgel, “Hoeffding and bernstein races for selecting policies in evolutionary direct policy search”, ln Proceedings of the 26th International Conference on Machine Learning (ICML), 2009.

[10] Benjamin Inden, “Neuroevolution and complexifying genetic architec-tures for memory and control tasks”, doi: 10.1007/s12064-008-0029-9, 2008.

[11] S. Hochreiter, “Untersuchungen zu dynamischen neuronalen Netzen.”, Diploma thesis, Institut f. Informatik, Technische Univ. Munich, 1991.

[12] S. Hochreiter, Y. Bengio, P. Frasconi and J. Schmidhuber, “Gradient flow in recurrent nets: the difficulty of learning long-term dependencies.”, A Field Guide to Dynamical Recurrent Neural Networks. IEEE Press, 2001.

[13] Pascanu Razvan, Mikolov Tomas, Bengio Yoshua, “On the difficulty of training Recurrent Neural Networks”, arXiv:1211.5063, 2012.

[14] Bengio Y., Simard P. and Frasconi P., “Learning long-term dependen-cies with gradient descent is difficult”, IEEE Transactions on Neural Networks, 5(2), 157-166, 1994.

[15] Vikhar, P. A.,“Evolutionary algorithms: A critical review and its future prospects”, Proceedings of the 2016 International Conference on Global Trends in Signal Processing, Information Computing and Communica¬tion. Jalgaon: 261-265.doi:10.1109 ICGTSPICC.2016.7955308, 2016.

[16] Shannon and Weaver, “The Mathematical Theory of Communication”, cf. note 78, p. 44, 1963.

[17] J. Schmidhuber, “Learning Complex, Extended Sequences Using the Principle of History Compression”, Neural Computation volume 4,num-ber 2, pp. 234-242, 1992.

[18] J. Lehman et al., “The Surprising Creativity of Digital Evolution”, Massachusetts Institute of Technology, Artificial Life Volume 26, Number 2: 274-306, 2020.

[19] Ole-Christoffer Granmo,“THE CONVOLUTIONAL TSETLIN MACHINE”, arXiv:1905.09688v5 [cs.LG], 27 Dec. 2019.

[20] Kaiming He, Xiangyu Zhang, Shaoqing Ren, Jian Sun, “Deep Residual Learning for Image Recognition”, arXiv:1512.03385 [cs.CV], 2015.

[21] Glorot Xavier, Bordes Antoine, Bengio Yoshua, “Deep Sparse Rectifier Neural Networks”, PMLR: 315-323, 2011.

[22] Y. LeCun, L. Bottou, G. B. On, K.-R. Muller, “Efficient backprop”, In Neural Networks: Tricks of the Trade, pages 9-50. Springer, 1998.

[23] Y. LeCun, et al., “Backpropagation applied to handwritten zip code recognition”, Neural computation, 1989.

[24] Hyeonwoo Noh, Tackgeun You; Jonghwan Mun; Bohyung Han, “Regularizing Deep Neural Networks by Noise: Its Interpretation and Optimization”, Conference on Neural Information Processing Systems, 2017.

[25] S. Ioffe and C. Szegedy, “Batch normalization: Accelerating deep network training by reducing internal covariate shift”, ICML, 2015.

[26] X. Glorot and Y. Bengio, “Understanding the difficulty of training deep feedforward neural networks”, AISTATS, 2010.

[27] Xiaodong Cui, Wei Zhang, Zoltan Tüske and Michael Picheny, “Evolutionary Stochastic Gradient Descent for Optimization of Deep Neural Networks”, 32nd Conference on Neural Information Processing Systems—NIPS, 2018.

[28] Yujin Tang, Duong Nguyen, David Ha, “Neuroevolution of Self-Interpretable Agents”, arXiv:2003.08165v2 [cs.NE], 2020.

[29] E. S. Marquez, J. S. Hare and M. Niranjan, “Deep Cascade Learning,” in IEEE Transactions on Neural Networks and Learning Systems, vol. 29, no. 11, pp. 5475-5485, doi: 10.1109/TNNLS.2018.2805098, 2018.

TABLE I
INIT MODEL TEST 1.

| LAYER | TYPE | OUTPUT | PARAMS |
|---|---|---|---|
| DV 0 500 1 | INPUTLAYER | N, 28, | 0 |
| | | 28, 1 | |
| DV 500 500 1 | FLATTEN | N, 784 | 0 |
| DV 1000 500 1 | DENSE | N, 10 | 7850 |

TOTAL PARAMS: 7,850

TABLE II
CHAMPION 1 INFORMATIONS.

| SCORE | CYCLE | GEN. | PARAMS | NODES | LAYER |
|---|---|---|---|---|---|
| 0.9944 | 96 | 19 | 409158 | 25 | 13 |

[symbol]

[symbol]

indicates data missing or illegible when filed

TABLE III
LIST OF MUTATIONS TO REACH THE CHAMPION MODEL

| STEP | MUTATION TYPE | LAYER |
|---|---|---|
| 1 | ADD SPLICE | CONV2D |
| 2 | ADD SPLICE | SEPARABLECONV2D |
| 3 | ADD SPLICE | LEAKYRELU, |
| | ADD SPLICE | CONV2D |
| 4 | SWAP LAYER | LEAKYRELU-DENSE |
| 5 | SWAP LAYER | DENSE-ACTIVATION |
| | ADD SPLICE | DENSE, |
| 6 | ADD NODE | DENSE, |
| | ADD NODE | CONV2D |
| 7 | MUTATE | DROPOUT |
| 8 | ADD CLONEDNODE | CONV2D |
| 9 | ADD LINK | |
| 10 | ADD LINK, | |
| | ADD LINK | |
| 11 | ADD SPLICE | GAUSSIANDROPOUT, |
| | ADD SPLICE | DENSE |
| 12 | ADD SPLICE | CONV2D |
| 13 | SWAP LAYER | ACTIVATION-DROPOUT |
| 14 | ADD SPLICE | DENSE |
| 15 | ADD SPLICE | DROPOUT, |
| | SWAP LAYER | DROPOUT-ACTIVATION |
| 16 | ADD SPLICE | ALPHADROPOUT |
| | MUTATE | DROPOUT |
| 17 | ADD SPLICE | ACTIVATION |
| 18 | MUTATE LL, | |
| | MUTATE LL, | |
| | ADD NODE | DENSE |
| 19 | SWAP LAYER | GAUSSIANDROP-DENSE |

TABLE IV
PHYLOGENETIC PATH AND SCORES
OF THE CHOSEN CHAMPION.

| SIZE | GENERATION | SCORE | SHANNON |
|---|---|---|---|
| 7850 | 0 | 8.79 | 12.51508 |
| 94906 | 1 | 97.51 | 8.98112 |
| 27082 | 2 | 98.43 | 8.97188 |
| 58538 | 3 | 98.96 | 8.98559 |
| 90346 | 4 | 99.03 | 8.98102 |
| 90282 | 5 | 99.03 | 8.96616 |
| 183818 | 6 | 99.23 | 8.95914 |
| 183818 | 7 | 99.19 | 8.95670 |
| 258570 | 8 | 99.24 | 8.94914 |
| 264330 | 9 | 99.29 | 8.93930 |
| 264970 | 10 | 99.30 | 8.92824 |
| 269130 | 11 | 99.27 | 8.92447 |
| 300874 | 12 | 99.28 | 8.92426 |
| 300874 | 13 | 99.33 | 8.91894 |
| 304970 | 14 | 99.34 | 8.91918 |
| 304970 | 15 | 99.34 | 8.91798 |
| 304970 | 16 | 99.35 | 8.91156 |
| 304970 | 17 | 99.36 | 8.90396 |
| 405486 | 18 | 99.41 | 8.90111 |
| 409158 | 19 | 99.44 | 8.90037 |

TABLE V
APPLYING DDL TO THE CHAMPION MODEL.

| | SCORE | SHANNON |
|---|---|---|
| BEST: | 99.05 | 9.1227 |
| MEAN: | 98.93 | 9.1615 |
| STDD: | 0.067 | 0.0168 |

TABLE VI
PRL OF THE CHAMPION MODEL.

| STEP | AVERAGE | STANDARD | BEST | AVERAGE |
|---|---|---|---|---|
| STEP | SCORE | DEVIATION | SCORE | SHANNON |
| — | 92.14 | 0.0771 | 92.33 | 12.5163 |
| 1 | 97.68 | 0.2711 | 98.11 | 8.9256 |
| 2 | 98.35 | 0.0925 | 98.58 | 8.9015 |
| 3 | 98.88 | 0.0841 | 99.02 | 8.9079 |
| 4 | 99.01 | 0.0676 | 99.16 | 8.8960 |
| 5 | 99.05 | 0.0634 | 99.13 | 8.8802 |
| 6 | 99.12 | 0.0553 | 99.23 | 8.8749 |
| 7 | 99.11 | 0.0541 | 99.22 | 8.8702 |
| 8 | 99.14 | 0.0515 | 99.27 | 8.8628 |
| 9 | 99.14 | 0.0660 | 99.26 | 8.8547 |
| 10 | 99.16 | 0.0647 | 99.32 | 8.8497 |
| 11 | 99.17 | 0.0700 | 99.35 | 8.8454 |
| 12 | 99.18 | 0.0563 | 99.31 | 8.8437 |
| 13 | 99.19 | 0.0641 | 99.34 | 8.8415 |
| 14 | 99.19 | 0.0626 | 99.34 | 8.8396 |
| 15 | 99.19 | 0.0618 | 99.31 | 8.8373 |
| 16 | 99.24 | 0.0606 | 99.36 | 8.8262 |
| 17 | 99.24 | 0.0521 | 99.37 | 8.8208 |
| 18 | 99.24 | 0.0542 | 99.35 | 8.8185 |
| 19 | 99.26 | 0.0628 | 99.40 | 8.8147 |

TABLE VII
STATISTIC ANALYSIS OF BOTH RESULTS.

| | DDL | PRL |
|---|---|---|
| MEAN | 98.9314% | 99.258% |
| VARIANCE | 4.502E−07 | 3.939E−07 |
| OBSERVATIONS | 50 | 50 |
| POOLED VARIANCE | 4.2204E−07 | |
| HYP. MEAN DIFF. | 0 | |
| DF | 98 | |
| T STAT | −25.13668 | |
| P(Tᵢ = T) ONE-TAIL | 8.0609E−45 | |
| T CRITICAL ONE-TAIL | 2.3650024 | |
| P(Tᵢ = T) TWO-TAIL | 1.6122E−44 | |
| T CRITICAL TWO-TAIL | 2.6269311 | |

TABLE VIII
COMPARISON OF SHANNON
ENTROPY BETWEEN LAYERS.

| NAME | | | TYPE | DDL | PRL |
|---|---|---|---|---|---|
| DV 250 | 500 | 1 | CONV2D | 9.1615 | 8.8147 |
| DV 375 | 500 | 1 | SEPCONV2D | 8.3719 | 8.2340 |
| DV 438 | 500 | 1 | CONV2D | 15.1592 | 15.1380 |
| DV 625 | 500 | 2 | DENSE | 14.7765 | 14.7274 |
| DV 812 | 500 | 6 | DENSE | 11.6829 | 11.6869 |
| DV 625 | 750 | 2 | CONV2D | 14.1550 | 14.0813 |
| DV 625 | 625 | 2 | CONV2D | 14.1858 | 14.0769 |
| DV 844 | 500 | 7 | DENSE | 12.1039 | 12.1009 |
| DV 875 | 500 | 11 | DENSE | 11.6835 | 11.6884 |
| DV 750 | 250 | 7 | DENSE | 17.4046 | 17.5115 |
| DV 938 | 750 | 2 | DENSE | 11.6889 | 11.7108 |
| DV 1000 | 500 | 26 | DENSE | 12.4659 | 12.5879 |

TABLE IX
DDL VS PRL COMPARISON
AT EVERY EVOLUTIONARY/COMPLEXIFICATION
STEP.

| | DDL | PRL |
|---|---|---|
| STEP | MAX SCORE | AVE SCORE |
| 0 | 92.140 | 92.144 |
| 1 | 98.160 | 97.679 |
| 2 | 98.130 | 98.347 |
| 3 | 98.470 | 98.879 |
| 4 | 98.430 | 99.007 |
| 5 | 98.420 | 99.048 |
| 6 | 98.560 | 99.115 |
| 7 | 98.780 | 99.105 |
| 8 | 98.770 | 99.135 |
| 9 | 98.940 | 99.138 |
| 10 | 98.760 | 99.161 |
| 11 | 98.870 | 99.173 |
| 12 | 98.870 | 99.179 |
| 13 | 98.760 | 99.193 |
| 14 | 98.860 | 99.186 |
| 15 | 98.750 | 99.192 |
| 16 | 98.860 | 99.239 |
| 17 | 98.860 | 99.239 |
| 18 | 98.820 | 99.243 |
| 19 | 98.790 | 99.258 |

TABLE X
SEED MODEL 2

| | | | | |
|---|---|---|---|---|
| 0 | 500 | INPUTLAYER | N, 28, 28, 1 | 0 |
| 250 | 500 | CONV2D | N, 27, 27, 6 | 30 |
| 500 | 500 | MAXPOOLING2D | N, 9, 9, 6 | 0 |
| 750 | 500 | FLATTEN | N, 486 | 0 |
| 1000 | 500 | DENSE | N, 10 | 4870 |

TABLE XI
CHAMPION 2 RESULTS.

| SCORE | CYCLE | GEN. | PARAMS | | NODES | LAYER |
|---|---|---|---|---|---|---|
| 0.9943 | 144 | 28 | 226 | 592 | 39 | 14 |

TABLE XII
RESULTS OF PRL APPLIED TO CHAMPION MODEL 2

| GEN | STD. | AVERAGE | CHAMPION 2 | DIRECT |
|---|---|---|---|---|
| STEP | DEV. | SCORE | SCORE | DDL STEP |
| 0 | 0.72% | 94.31% | 94.60% | 96.37% |
| 1 | 0.59% | 95.81% | 95.96% | 96.09% |
| 2 | 0.48% | 96.48% | 95.35% | 97.38% |
| 3 | 0.26% | 97.78% | 97.72% | 97.33% |
| 4 | 0.12% | 98.28% | 98.35% | 98.46% |
| 5 | 0.13% | 98.54% | 98.34% | 98.47% |
| 6 | 0.09% | 98.73% | 98.71% | 98.59% |
| 7 | 0.11% | 98.50% | 98.40% | 98.75% |
| 8 | 0.11% | 98.56% | 98.60% | 98.63% |
| 9 | 0.20% | 98.51% | 98.73% | 98.69% |
| 10 | 0.11% | 98.73% | 98.84% | 98.80% |
| 11 | 0.22% | 98.67% | 98.84% | 98.87% |
| 12 | 0.11% | 98.91% | 98.99% | 98.71% |
| 13 | 0.11% | 98.98% | 99.04% | 98.86% |
| 14 | 0.06% | 99.01% | 99.07% | 98.92% |
| 15 | 0.05% | 99.11% | 99.14% | 98.71% |
| 16 | 0.07% | 99.11% | 99.18% | 98.96% |
| 17 | 0.05% | 99.15% | 99.09% | 98.96% |
| 18 | 0.06% | 99.19% | 99.15% | 98.84% |
| 19 | 0.05% | 99.17% | 99.20% | 98.98% |
| 20 | 0.06% | 99.18% | 99.24% | 98.93% |
| 21 | 0.06% | 99.18% | 99.31% | 98.97% |
| 22 | 0.04% | 99.14% | 99.31% | 98.91% |
| 23 | 0.06% | 99.14% | 99.24% | 98.90% |
| 24 | 0.07% | 99.14% | 99.32% | 99.02% |
| 25 | 0.07% | 99.18% | 99.33% | 98.86% |
| 26 | 0.08% | 99.13% | 99.37% | 98.97% |
| 27 | 0.06% | 99.18% | 99.35% | 98.92% |
| 28 | 0.06% | 99.19% | 99.43% | 98.83% |

TABLE XIII
SHANNON LAYER COMPARISON FOR FASHION MNIST.

| NAME | | | TYPE | DDL | PRL |
|---|---|---|---|---|---|
| DV 250 | 500 | 1 | CONV2D | 9.0238 | 8.4813 |
| DV 375 | 500 | 1 | SEPCONV2D | 8.3070 | 8.0439 |
| DV 438 | 500 | 1 | CONV2D | 15.1492 | 15.1338 |
| DV 625 | 500 | 2 | DENSE | 14.7804 | 14.7331 |
| DV 812 | 500 | 6 | DENSE | 11.6941 | 11.6841 |
| DV 625 | 750 | 2 | CONV2D | 14.1506 | 13.9888 |
| DV 625 | 625 | 2 | CONV2D | 14.1568 | 13.9923 |
| DV 844 | 500 | 7 | DENSE | 12.1115 | 12.1017 |
| DV 875 | 500 | 11 | DENSE | 11.6922 | 11.6905 |
| DV 750 | 250 | 7 | DENSE | 17.3703 | 17.4783 |
| DV 938 | 750 | 2 | DENSE | 11.6984 | 11.7100 |
| DV 1000 | 500 | 26 | DENSE | 12.3777 | 12.5757 |

What is claimed is:

1. A method, comprising:
training an initial model on a first dataset;
iterating over multiple generations, with at least one mutation in each of the multiple generations, to identify a champion model;
storing a trace of evolutionary steps from the initial model to the champion model; and
replaying the evolutionary steps with modified synaptic weights, random weights when adding new nodes, or a combination of both.
